(19) United States
(12) Patent Application Publication
(10) Pub. No.: US 2014/0130313 A1
(43) Pub. Date: May 15, 2014

(54) SNAP HOOK FOR ANIMAL

(71) Applicants: Satoshi Tozawa, Osaka (JP); Masashi Tozawa, Osaka (JP)

(72) Inventors: Satoshi Tozawa, Osaka (JP); Masashi Tozawa, Osaka (JP)

(73) Assignee: RALLOC CO., LTD., Osaka, (JP)

(21) Appl. No.: 14/130,073

(22) PCT Filed: Jul. 25, 2012
(86) PCT No.: PCT/JP2012/068766

§ 371 Date: Dec. 30, 2013

(30) Foreign Application Priority Data
Jul. 29, 2011 (JP) 2011-167611

(51) Int. Cl. A01K 27/00

(52) U.S. Cl. CPC A01K 27/005
USPC 24/455

(57) ABSTRACT

A snap hook includes a main body having hook and sleeve portions extending from a base, ends of the hook portion and sleeve portions being opposed to each other to define an opening of the hook portion; a pin which moves back from and towards the end of the hook portion so as to open and close the opening, the pin including an operating portion including a ridge exposed to outside through a sliding slit of the sleeve portion; and a spring for biasing the pin toward the end of the hook portion so as to achieve contact. The main body includes a restraining wall which extends from the base and between the sleeve portion and the hook portion, toward a connection where the hook portion is joined to a connection object so as to restrict the connection between the end of the hook portion and the connection object.

### FIELD

The present invention relates to a snap hook for an animal, generally used for connecting a leash for leading or holding an animal to a connection ring provided on a collar or a cloth of an animal such as a dog or cat.

### BACKGROUND

The snap hook includes a hook portion generally called a loop clutch with an opening formed therein for accepting a connection object. FIG. 20 shows a state of a leash 151 being connected to a collar 152 of a dog a by means of a conventional snap hook 150 for dog-walking. The snap hook 150 in which a C-shaped hook portion 111, called a loop clutch (hereinafter, “loop clutch 111”), is formed is attached to an end of the leash 151. The loop clutch 111 is configured so as to be attached to or detached from a ring 153 attached to the collar 152.

With reference to FIG. 21, there is shown a snap hook 150a. The snap hook 150a includes: a hook member 113 integrally formed by the loop clutch 111 and a sleeve portion 112; and a connection ring 114 for anchoring the leash 151. The sleeve portion 112 includes a large-diameter portion 116, a small-diameter portion 117, and a large-diameter portion 115 formed in this order from a sleeve end opposite to the loop clutch 111 toward the loop clutch 111. A through hole 114a is formed in one side (a straight portion) of the D-shaped connection ring 114. The connection ring 114 is rotatably attached to the sleeve portion 112 (the hook member 113) with the small-diameter portion 117 being fitted to the through hole 114a, i.e., with the large-diameter portion 116 and the large-diameter portion 115 interposing the one side (the straight portion) of the connection ring 114 therebetween.

The sleeve portion 112 includes a hole 122 with a bottom, which is formed along an axial direction Ds, and has an opening 121 at an end face 112a closer to the loop clutch 111. The sleeve portion 112 includes a guiding slit 123 formed along the axial direction Ds, starting from the opening 121. Inside the hole 122, a coil spring 124 and a slide bar 125 movable along the axial direction are inserted in this order so that the coil spring 124 is compressed by the slide bar 125. The slide bar 125 is biased so that an end of the slide bar 125 comes into contact with the end face 111a of the loop clutch 111 due to a force of the compressed coil spring 124 to expand. The slide bar 125 includes an integrally-formed protruding knob portion 126, and the knob portion 126 is attached so as to project from the guiding slit 123 toward the outside of the hole 122.

In the snap hook 150a, when the knob portion 126 is slid toward the connection ring 114 temporarily against the biasing force of the coil spring 124, an end face of the slide bar 125 and the end face 111a of the loop clutch 111 are separated from each other, thereby forming a gap therebetween. The knob portion 126 is an operating portion for making a slide movement of the slide bar 125. In this sense, the knob portion 126 is hereinafter referred to as the “operating portion 126.”

By hooking the loop clutch 111 to the ring 153 of the collar 152 (FIG. 20) while the gap is being formed, the ring 153 and the loop clutch 111 (hook member 113) can be connected to each other. Thereafter, the end face of the slide bar 125 is again brought into contact with the end face 111a of the loop clutch 111 so as to close the loop clutch 111 with the slide bar 125.

In FIG. 22, shown is a snap hook 150b, another example of the conventional snap hook 150 (Patent Literature 1). The snap hook 150b is obtained by adding a locking mechanism for locking the slide bar 125 to the snap hook 150a in order to prevent the movement of the slide bar 125 against user's intention. FIG. 22(a) shows the snap hook 150b in a normal state where the locking mechanism is not in operation. FIG. 22 (b) shows the snap hook 150b in a transient state making up a transition to a locked state where the locking mechanism is in operation. FIG. 22 (c) shows the snap hook 150b in the locked state where the locking mechanism is in operation.

As can be seen from FIG. 22, the sleeve portion 112 includes an L-shaped locking slit 131 branched from the guiding slit 123. The locking slit 131 is formed by a transverse slit 132 extended by a predetermined distance in a direction perpendicular to the axial direction Ds and a longitudinal slit 133 extended by a predetermined distance in the axial direction Ds from an extended end of the transverse slit 132 toward the end side of the sleeve portion 112. Note that a position at which the transverse slit 132 is formed corresponds to a position of the operating portion 126 when the slide bar 125 is slid against the coil spring 124 in the axial direction Ds so as to separate the slide bar 125 from the loop clutch 111.

As shown in FIG. 22(a), when the slide bar 125 comes into contact with an opening end of the loop clutch 111 (when the loop clutch 111 is closed), the operating portion 126 cannot enter the transverse slit 132. In order to allow the operating portion 126 to enter the transverse slit 132, the slide bar 125 needs to be slid in a direction to open the loop clutch 111 (toward the connection ring 114). In other words, the operating portion 126 is prevented from entering the transverse slit 132 in an unexpected manner.

There will be described a typical operation when the snap hook 150b is used. When the snap hook 150b is not in use, it is in the normal state shown in FIG. 22(a). In order to connect the snap hook 150b to the ring 153 of the collar 152 (FIG. 20), the operating portion 126 is slid strongly along the guiding slit 123 so as to move the slide bar 125 toward the connection ring 114. By doing so, a space between the end face 111a of the loop clutch 111 and the end face 112a of the sleeve portion 112 is opened widely. While keeping such a state, the snap hook 150b is hooked to the ring 153.

After being hooked to the ring 153, the operating portion 126, along the way it is returning to its original position, is moved in a direction of the transverse slit 132 when the operating portion 126 comes to the position of the transverse slit 132 as shown in FIG. 22(b). Then, once the operating portion 126 is moved up to the end of the transverse slit 132, the slide bar 125 is pushed by the biasing force of the coil spring 124. As a result, the operating portion 126 now moves along the longitudinal slit 133 as shown in FIG. 22(c). Then, the operating portion 126 is stopped at a position where an end face 125a of the slide bar 125 comes into contact with the end face 111a of the loop clutch 111.

After that, a range over which the operating portion 126 can move in the axial direction Ds is restricted within the inside of the longitudinal slit 133. Thus, even if the operating portion 126 is pushed in the axial direction Ds so as to move the slide bar 125 toward the connection ring, an amount of movement in the slide bar 125 is limited. Therefore, only a half state can be obtained. Even if a force in a direction such as to rotate the slide bar 125 (perpendicular to the axial direction Ds) is applied to the operating portion 126, the movement of the operating portion 126 in the rotating direction is restricted by the longitudinal slit 133 to prevent the slide bar 125 from moving to open as long as a force in the axial direction Ds is not applied thereto simultaneously. In other words, the locking slit 131 and the operating portion 126 together form the locking mechanism for preventing the movement of the slide bar 125 against user's will.

### CITATION LIST

### Patent Literature

Patent Literature 1: Japanese Patent Application Laid-Open No. 2009-72080

### SUMMARY

### Technical Problem

Any of the above-described conventional snap hooks is configured so that the slide bar and the locking mechanism serve to close the hook portion (loop clutch) while being connected to another member. As long as these are functioning properly, the connected state is maintained securely. Depending on a usage thereof, however, the connection therebetween may be unexpectedly detached.

For example, the snap hook 150a has a problem such that the connection between the hook member 113 and the ring 153 may be unexpectedly detached due to an unexpected action of an animal (dog a) such as when frightened or attracted by something while the animal is led or held. Such an unexpected detachment is caused by an unexpected action of an animal. In other words, due to an unexpected action of an animal, the ring 153 of the collar 152 may possibly push and move the operating portion 126 of the loop clutch 111. If the animal continuously moves irregularly, the slide bar 125 (operating portion 126) may be pushed back for some reason against user's will, thereby exposing the opening of the hook member 113 and resulting in the detachment of the ring 153.

Also, in the snap hook 150b (Patent Literature 1), the ring 153 (FIG. 20) driven by the action of an animal may cause the operating portion 126 being locked in the longitudinal slit 133 to be moved along the longitudinal slit 133 and then led to the transverse slit 132, resulting in a half-locked state. Due to a further action of the animal, the operating portion 126 in the half-locked state may be guided along the transverse slit 132 and then moved to the guiding slit 123 by the ring 153, resulting in an unlocked state. The operating portion 126 in the unlocked state cannot completely avoid a situation such that it is guided along the guiding slit 123 by the ring 153 due to a further action of the animal and pushed back against the biasing force of the coil spring 124 up to a position where the loop clutch 111 is fully opened.

As described above, none of the snap hook 150a and the snap hook 150b can avoid the transmission of the movement of the ring 153 as a connection object, such as when driven by the action of an animal being held, to the slide bar 125 via the operating portion 126. As a result, the snap hook 150a and the snap hook 150b both have a problem that the connection may be detached against user's will.

In light of the above-described problem, it is an object of the present invention to provide a snap hook for an animal, capable of preventing the movement of the connection object from being transmitted to the slide bar as a force for pushing it back.

### Solution to Problem

In order to achieve the above object, a snap hook for an animal according to the present invention comprises:

a main body having a hook portion and a tubular sleeve portion integrally extending from a base, to which a base ring is rotatably connected, the sleeve portion and an end of the hook portion being opposed to each other to define an opening of the hook portion;

an engage pin being encased in the sleeve portion of the main body such that it can move back away from and move forth toward the end of the hook portion so as to open and close the opening, the engage pin including an operating portion used for the opening and closing operations, the operating portion being provided with a ridge member exposed to outside through a sliding slit formed on a peripheral wall of the sleeve portion; and

a spring for biasing the engage pin toward the end of the hook portion so as to achieve contact therebetween, thereby maintaining the opening at a closed position, wherein

one feature of this invention is that the main body includes a restraining wall which extends from the base and between the sleeve portion and the hook portion, toward a connection part where the hook portion is joined to a connection object so as to restrict the connection part between the end of the hook portion and the connection object and an allowance toward the base and which also defines a restraining window communicating with the opening and allowing for ingress and egress of the connection object.

In order to achieve the above object, a snap hook for an animal according to the present invention also comprises:

a main body having a hook portion and a tubular sleeve portion integrally extending from a base, to which a base ring is rotatably connected, the sleeve portion and an end of the hook portion being opposed to each other to define an opening of the hook portion;

an engage pin being encased in the sleeve portion of the main body such that it can move back away from and move forth toward the end of the hook portion so as to open and close the opening, the engage pin including an operating portion used for the opening and closing operations, the operating portion being provided with a ridge member exposed to outside through a sliding slit formed on a peripheral wall of the sleeve portion; and

a spring for biasing the engage pin toward the end of the hook portion so as to achieve contact therebetween, thereby maintaining the opening at a closed position, wherein

another feature of this invention is that: the main body includes a restraining wall which extends from the base and between the sleeve portion and the hook portion, toward a connection part where the hook portion is joined to a connection object so as to restrict the connection part between the end of the hook portion and the connection object and an allowance toward the base and which also defines a restraining window communicating with the opening and allowing for ingress and egress of the connection object; and

with respect to the operating portion at a position corresponding to a closed position of the engage pin, the sleeve portion on the side of the hook portion includes a guard portion extruding more in an outward direction than at least an end on the side of the hook portion in a body of the operating portion so as to prevent an unexpected hitching force from being exerted on the body and the ridge member of the operating portion from the hook portion side.

Each of the above-described inventions may be further characterized in that: the sleeve portion is configured by integrating together a portion integrally formed with the main body and a divided body formed separately from the main body with the engage pin and the spring interposed therebetween; the sliding slit, facing a contour of the main body formed by the sleeve portion and the hook portion arranged side by side or a surface at which the sleeve portion and the hook portion are arranged side by side, is formed at an interface between the integrally-formed portion and the divided body; and the guard portion positioned on the hook portion side of the sliding slit is formed by both or either of the integrally-formed portion and the divided body.

The above and other objects and features of the present invention will become apparent from the following detailed description given in conjunction with the drawings. The features of the present invention can be employed independently or in various combinations to the extent possible.

### Advantageous Effects of Invention

According to the one feature of the snap hook for an animal of the present invention, the movement of the connection object, such as to come into contact with the operating portion and thereby push back the engage pin, is restricted by the restraining wall extending from the base of the main body and between the sleeve portion and the hook portion, toward the connection part where the hook portion is joined to the connection object. Also, the connection object as well as a passing object, such as a fabric or string of a cloth worn around the torso of a dog or the like being connected or an object provided with protrusions and recesses, are restrained from hitching the operating portion in a direction of pushing back the engage pin, i.e., in a direction of an opening operation, without inhibiting an intended opening operation accompanied by a pressing action by the ball of a finger with resiliency, due to the ridge member in the operating portion of the engage pin exposed from the sleeve portion. Thus, the opening of the hook portion can be prevented from being exposed unexpectedly and the connection object is thus prevented from being detached from the snap hook.

According to the another feature of the snap hook for an animal of the present invention, in addition to the case of the above-described one feature, the guard portion of the sleeve portion extrudes more in the outward direction than at least the end of the exposed ridge member of the operating portion on the side of the hook portion. Consequently, the main body of the operating portion as well as the ridge member thereof are actively blocked and restrained from being hitched by not only the connection object but also a passing object approaching from the hook portion side, such as a fabric or string of a cloth worn around the torso of a dog or the like being connected or an object provided with protrusions and recesses, in the direction of pushing back the engage pin, i.e., in the direction of the opening operation, without particularly inhibiting an intended opening operation accompanied by a settlement due to resiliency, obtained by a pressing action by the ball of a finger. Thus, the opening of the hook portion can be adequately prevented from being exposed unexpectedly, and the connection object is thus prevented from being detached from the snap hook.

According to the further feature in each of the first and second features, since the sleeve portion is configured by integrating together the portion integrally formed with the main body and the divided body with the engage pin and the spring interposed therebetween, a need to encase the engage pin from the hook portion side can be eliminated. Also, an exposure of the ridge member of the operating portion can be achieved by the sliding slit which faces the contour of the main body formed by the sleeve portion and the hook portion arranged side by side or the surface at which the sleeve portion and the hook portion are arranged side by side. Furthermore, since the guard portion, positioned on the hook portion side of the sliding slit, is formed by both or either of the integrally-formed portion and the divided body, the opening of the hook portion can be prevented from being exposed unexpectedly and the connection object is thus prevented from being detached from the snap hook. In particular, in comparison with the case where the ridge member is exposed so as to face the contour of the main body, the probability of avoiding the occurrence of hitching, made by the connection object as well as a passing object, such as a fabric or string of a cloth worn around the torso of a dog or the like being connected or an object provided with protrusions and recesses, and exerted in the direction of the opening operation from the hook portion side, can be further increased by the ridge member of the operating portion being exposed so as to face the surface at which the sleeve portion and the hook portion are positioned side by side.

### BRIEF DESCRIPTION OF DRAWINGS

FIG. 1 is a partially-cutaway view illustrating an internal configuration of a snap hook for an animal according to a first embodiment of the present invention.

FIG. 2 is a cross-sectional view of the snap hook taken along the line II-II in FIG. 1.

FIG. 3 is a cross-sectional view of the snap hook taken along the line in FIG. 1.

FIG. 4 is a side view of the snap hook, showing an engage pin as viewed in the direction of arrow IV in FIG. 1.

FIG. 5 is a side view of the snap hook as viewed in the direction of arrow V in FIG. 1.

FIG. 6 is a side view of the engage pin shown in FIG. 1.

FIG. 7 is a front view of a snap hook for an animal according to a second embodiment of the present invention.

FIG. 8 is a cross-sectional view of the snap hook taken along the line VIII-VIII in FIG. 7.

FIG. 9 is a side view of the snap hook, showing an engage pin as viewed in the direction of arrow IX in FIG. 7.

FIG. 10 is a side view of the engage pin shown in FIG. 7.

FIG. 11 is a perspective view illustrating an example of a state in which the snap hook shown in FIG. 7 is joined to a connection object.

FIG. 12 is a view illustrating an example of a state in which an operating portion of the snap hook shown in FIG. 7 comes into contact with the connection object.

FIG. 13 is a side view of a snap hook for an animal according to a third embodiment of the present invention.

FIG. 14 is a partially-cutaway view of a main body of the snap hook shown in FIG. 13.

FIG. 15 is a perspective view of the main body of the snap hook shown in FIG. 14.

FIG. 16 is a side view of a snap hook for an animal according to a fourth embodiment of the present invention.

FIG. 17 is a partially-cutaway view of a main body of the snap hook shown in FIG. 16.

FIG. 18 is a perspective view of the main body of the snap hook shown in FIG. 16.

FIG. 19 is a front view of a main body of a snap hook for an animal according to a fifth embodiment of the present invention.

FIG. 20 shows a state in which a conventional snap hook is used for connecting a collar of a dog and a leash together for dog walking.

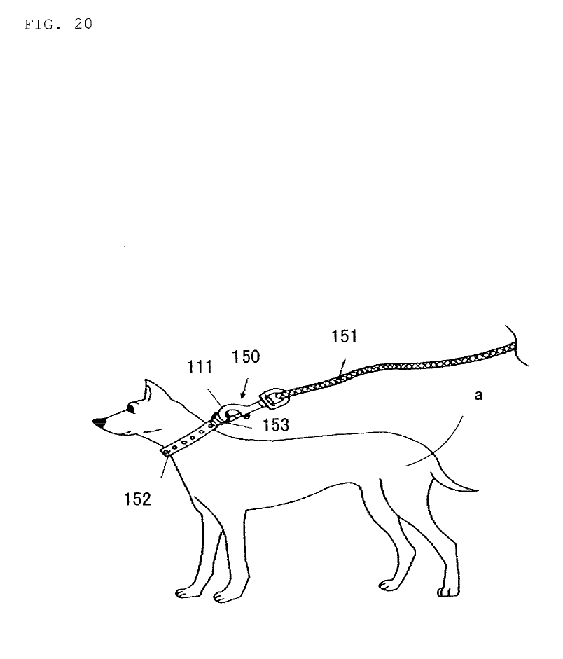

FIG. 21 is a view illustrating an exemplary configuration of the conventional snap hook.

FIG. 22 is a view illustrating another configuration of the conventional snap hook, different from that shown in FIG. 21.

### DESCRIPTION OF EMBODIMENTS

Prior to describing embodiments of the present invention in detail, the technical feature of the present invention will be briefly discussed. The present invention is configured so as to prevent the movement of a connection object from being transmitted to a slide bar as a force for pushing it back. For the sake of this, there is provided means for preventing the connection object from coming into contact with an operating portion of the slide bar or reducing an intensity of such contact. The means are classified broadly into two kinds.

The first means is means for restricting the movement of the connection object so that it cannot come into contact with the operating portion, by restricting a range of movement of the connection object in a hook portion of a snap hook. The first means is provided in the hook portion. The second means is means provided in the vicinity of the operating portion for receiving the connection object so as to prevent the connection object from coming into contact with the operating portion.

### First Embodiment

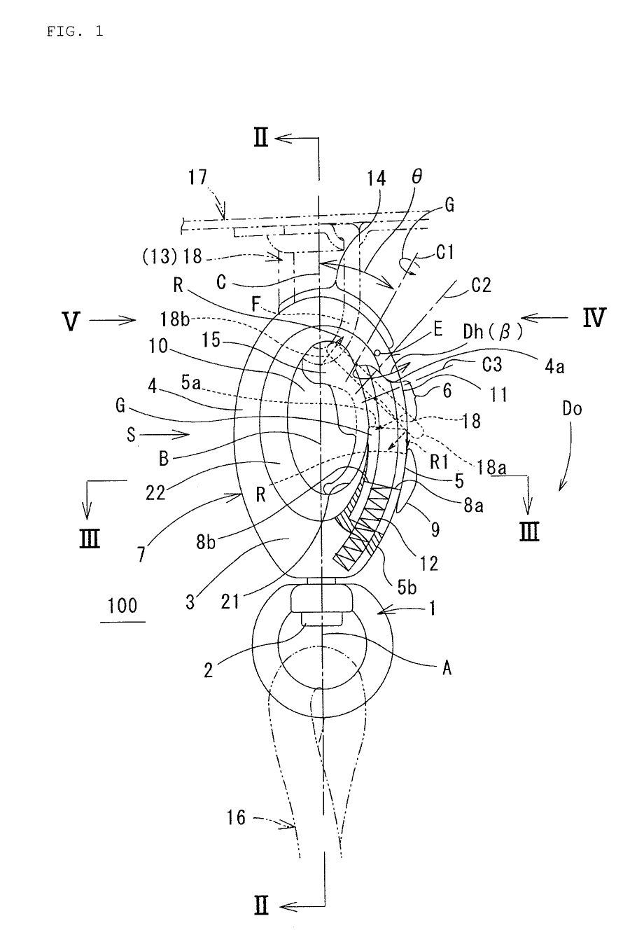

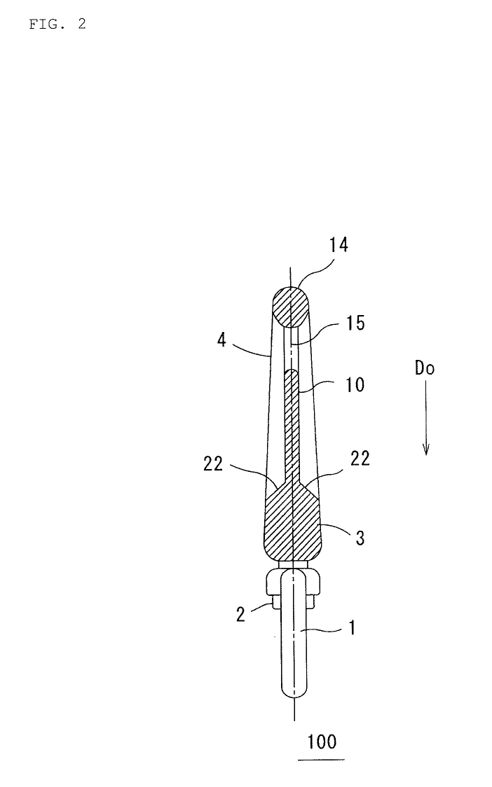

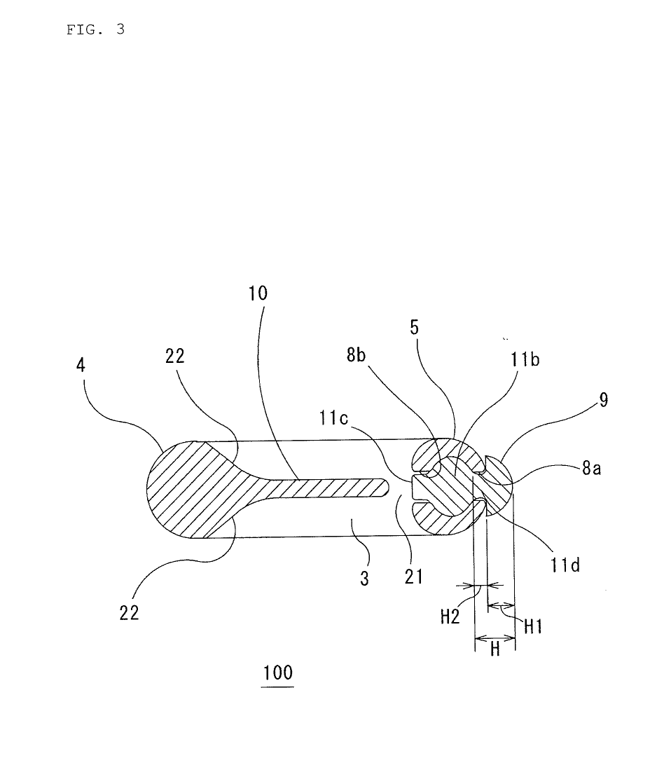

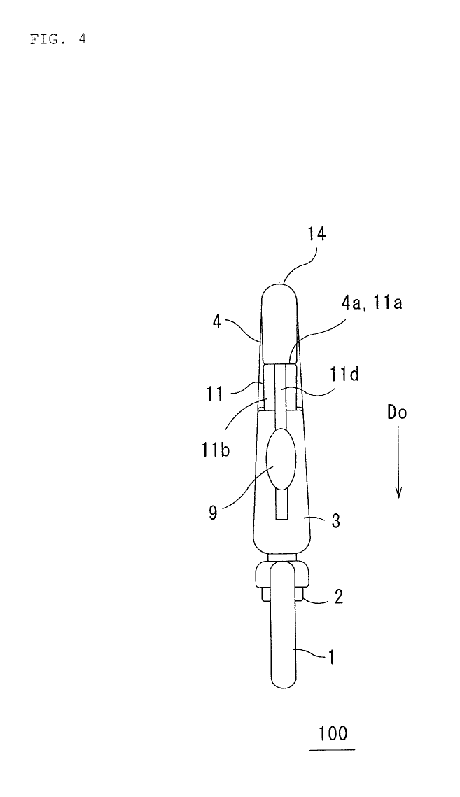

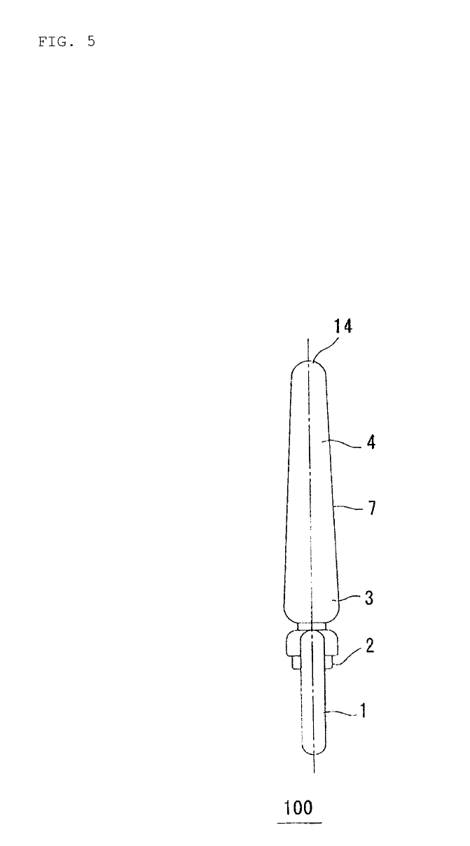

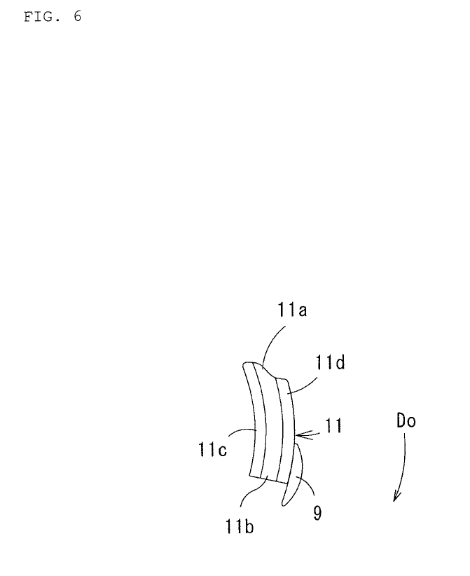

A snap hook for an animal-according to the first embodiment of the present invention will now be described with reference to FIG. 1, FIG. 2, FIG. 3, FIG. 4, FIG. 5, and FIG. 6. The present embodiment is a specific example of the present invention, and is not intended to limit the description of claims.

A snap hook 100 for an animal (hereinafter the “snap hook”) according to the present embodiment has a basic configuration including: a main body 7 of a generally elliptic shape; an engage pin 11 slidably encased in a long side portion of the main body 7; and a spring 12 that can be encased inside the main body 7. In the main body 7, a hook portion 4 and a tubular sleeve portion 5 integrally extend from a base 3 to which a base ring 1 is rotatably connected via a stem 2. The sleeve portion 5 is opposed to an end 4a of the hook portion 4 so as to define an opening 6 of the hook portion 4.

As shown in FIG. 3 and FIG. 6, an operating portion 9 is provided so as to project by a predetermined height H (hereinafter referred to as the “operating portion projecting height H”) outwardly from a body 11b of the engage pin 11. As shown in FIG. 1 and FIG. 3, the engage pin 11 is encased in the sleeve portion 5 of the main body 7 from the end 4a of the hook portion 4 so that the operating portion 9 is projected outwardly and thereby exposed through a sliding slit 8a on a peripheral wall of the sleeve portion 5 by a predetermined height H1 (hereinafter referred to as the “operating portion exposed height H1”). A height from a lower end of the operating portion 9 to a lower end of the sleeve portion 5 (the operating portion projecting height H—the operating portion exposed height H1) is referred to as an operating portion lower end height H2. The spring 12 biases the engage pin 11 so as to cause the engage pin 11 to come into contact with the end 4a of the hook portion 4, thereby maintaining the opening 6 at a closed position.

In order to achieve the main object of the present invention, the main body 7, in particular, includes a restraining wall 10. The restraining wall 10 extends from the base 3 and between the sleeve portion 5 and the hook portion 4, toward a connection part 14 between the hook portion 4 and the connection object 13 so as to restrict the connection part 14 from the end 4a of the hook portion 4 to the connection object 13 and an allowance to the base 3. The restraining wall 10 also defines a restraining window 15 which communicates with the opening 6 and allows for the ingress and egress of the connection object 13. The restraining wall 10 corresponds to the first means for restricting the movement of the connection object so that it cannot be allowed to come into contact with the operating portion by restricting a range of movement of the connection object in the hook portion of the above-described snap hook.

In the state shown in FIG. 1, the snap hook 100 is used to lead and hold animals. Specifically, the main body 7 is connected to a leash 16 for leading or a leash for holding an animal (not shown) with the base ring 1, and is also connected to a connection ring such as a D-ring 18 provided on a harness or cloth (not shown) such as a collar 17 and so on for an animal at the hook portion 4.

An unexpected action of an animal, such as when frightened or attracted by something while the animal is led or held, is more likely to cause an entanglement due to a twist generated between the snap hook 100 and the D-ring 18 or the like. Such an entanglement is more likely to occur since the twist is less likely to be cancelled out by the free rotation of the base ring 1 due to an inclination between an axis of the hook portion 4 and an axis of the D-ring 18 (hereinafter referred to as an “entanglement angle”). The main body 7 and the D-ring 18 will be twisted with such an entanglement angle maintained.

In a case where a degree of freedom in the relative movement between the hook portion and the D-ring (hereinafter referred to as “a degree of movement freedom”) is high as with the conventional snap hook, such an entanglement can be exacerbated due to an influence of the entanglement angle therebetween if the D-ring moves relatively with respect to the hook portion. In other words, depending on the direction and state of the entanglement, a degree of freedom in the position or movement of the D-ring with respect to the hook portion can be eliminated. Thus, almost inevitably, there is created a risk that part of the D-ring, positioned outside the hook portion, comes into contact with the operating portion to push back the engage pin, thereby exposing the opening of the loop clutch against user's intention, although the probability thereof is low.

With the loop clutch being opened, part of the D-ring, positioned inside the hook portion, is moved along the inner circumferential curved shape of the hook portion so as to approach the opening of the hook portion. As a result, following a preceding part having made the engage pin retracted to expose the opening, a following part comes off out of the hook portion through the exposed opening, resulting in an unexpected (against user's will) detachment of the D-ring from the hook portion. Where appropriate, part of the D-ring positioned outside the hook portion, which serves to expose the opening of the loop clutch by coming into contact with the hook portion, is referred to as the “preceding part”. Part of the D-ring positioned inside the loop clutch, which approaches the opening of the loop clutch exposed by the “preceding part” of the D-ring, is referred to as the “following part.”

In the snap hook 100 where the hook portion 4 and the sleeve portion 5 integrally extend from the base 3, the size of the main body 7 is determined in accordance with (in a manner such that it can withstand) a load applied thereto and the handling thereof, such as, connecting the hook portion 4 to a connection object such as the D-ring 18 and operating the operating portion 9 of the engage pin 11. The restraining wall 10 is formed extending from the base 3 of the main body 7 and between the sleeve portion 5 and the hook portion 4 toward the connection part 14 where the hook portion 4 is joined to the D-ring 18 or the like. The restraining window 15 is formed between the restraining wall 10 and the connection part 14 of the hook portion 4. The connection object such as the D-ring 18 can be connected to the connection part 14 by being inserted into an opened part of the restraining window 15 through the opening 6 having been exposed by the retraction of the engage pin 11.

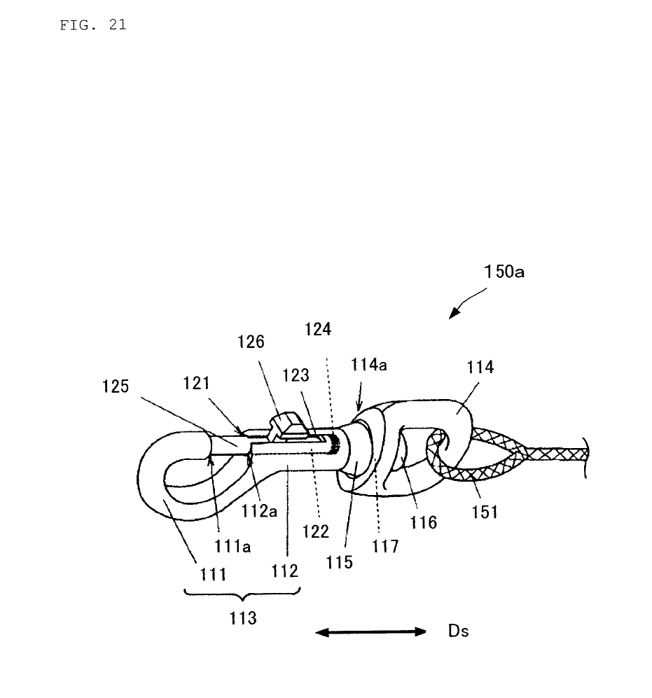

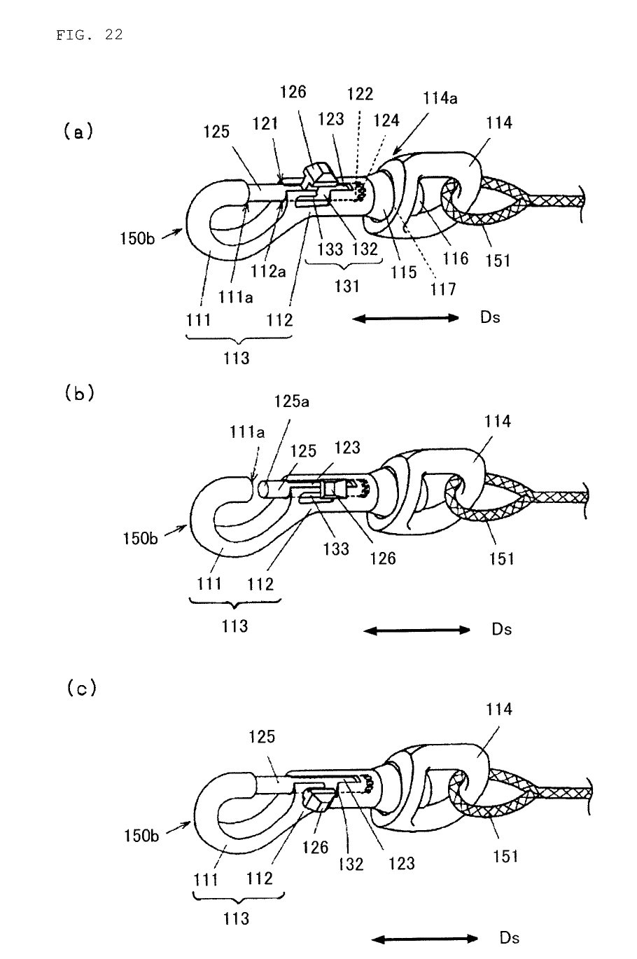

The movement of the D-ring 18 or the like within the hook portion 4 after the connection, at which time the engage pin 11 has returned to the closed position, is restricted by the restraining wall 10 within a range adjacent to the connection part 14 inside a contour thereof (FIG. 1). Thus, the D-ring 18 is prevented from moving in a pull-down direction Do so as to contact itself with the operating portion 9 that makes the engage pin 11 go down. As a result, avoided is unexpected exposion of the opening 6 of the hook portion 4 resulting in that the detachment of the connection object 13 can be prevented. While the above-described axial direction Ds (FIG. 21 and FIG. 22) is linear and bidirectional, the pull-down direction Do is a direction corresponding to a curved movement of the engage pin 11 when slid against the biasing force of the spring 12 along the generally-elliptic long side portion of the main body 7 so as to separate the end of the engage pin 11 from the end of the hook portion 4.

The detailed description will now be made based on the illustrated example. The base ring 1 is rotatably connected by the stem 2 positioned on the base 3 of the main body 7 and coaxially provided at a position opposite to the center of the connection part 14 of the hook portion 4. Under conditions where a movement of an animal is limited when the animal is led or held, tension is generally exerted between the D-ring 18 and the base ring 1 by pulling the leash 16 or the like. The base ring 1, the hook portion 4, and the D-ring 18 are linearly arranged so that their axes A, B, and C are approximately aligned with one another as shown in FIG. 1. This is because of a centripetal tendency with respect to the tension due to the curved portions of the base ring 1, the hook portion 4, and the D-ring 18 or the like. In this linear arrangement, a twist generated between an object such as the leash 16 to which the hook portion 4 is connected, and an object such the D-ring 18 to which the base ring 1 is connected, is cancelled out by the rotation between the base ring 1 and the main body 7 about the stem 2.

However, due to an unexpected action of an animal, the axis C of the D-ring 18 may incline with respect to the axis B of the hook portion 4 toward the opening 6 with an entanglement angle θ, as illustrated by C1, C2, and C3 in FIG. 1, for example. Under such a condition, the larger the entanglement angle θ is, the harder the cancellation of the twist is achieved due to the rotation of the D-ring 18. The cancellation of the twist is even harder to be achieved in a case where the twist occurs instantly. Corresponding to an uncancelled amount of the twist, the hook portion 4 and the D-ring 18 are pressed against each other at two points E and F in an entangled pose according to an entangling direction. The points E and Fare located on front and back sides of their curved portions so as to sandwich the axis C. Then, the hook portion 4 moves toward the center of the D-ring 18, and the D-ring 18 moves toward the center of the hook portion 4, increasing the entanglement as they approach each other. Furthermore, with respect to a plane at which the hook portion 4 is positioned, the axis C of the D-ring 18 turns around the hook line of the connection part 14 of the hook portion 4 and the axis line of the engage pin 11, i.e., turns around toward the reverse side in a direction Dh.

Specifically speaking, as a turn-around angle β approaches 90°, the front-side pressed point E, shown by a solid line in FIG. 1, approaches toward the outer circumferential portion of the hook portion 4. As the pressed point F, shown by a broken line, approaches toward the inner circumferential portion of the hook portion 4, the entanglement caused by the twist between the hook portion 4 and the engage pin 11 forces the D-ring 18 to approach the hook portion 4 and the engage pin 11 along both or either of the curved portions of the connection part 14 of the hook portion 4 and the engage pin 11 at the pressed points E and F. Thus, the D-ring 18 is likely to be led toward the operating portion 9 naturally. Such a tendency is similar to the conventional snap hook.

In the specific example of the snap hook 100 according to the present embodiment, however, the approach of the D-ring 18 toward the hook portion 4 and the engage pin 11 due to the entanglement caused by the twist between the hook portion 4 and the engage pin 11 is confined within the restraining window 15. In other words, as the D-ring 18 moves, and then eventually comes into contact with the restraining wall 10, the D-ring 18 cannot approach toward the hook portion 4 and the engage pin 11 more. In a case where there exists no turn-around angle β, the D-ring 18 may be guided along both of the curved portions of the hook portion 4 and the D-ring 18, attempting to approach the hook portion 4 along the axis C1 and the axis C2, depending on the condition of twist of the D-ring 18 around the axis C1 and that around the axis C2.

However, the D-ring 18 will soon come into contact with the restraining wall 10, whereby the progress of the entanglement is prevented. The D-ring 18 is thus prevented from touching and pushing back the operating portion 9, even if the D-ring 18 is led toward the operating portion 9. Depending on the condition of twist of the D-ring 18 around the axis C3, the D-ring 18 is moved along one of the curved portions of the D-ring 18 which has a smaller curvature and led toward the hook portion 4 and the engage pin 11. Also in this case, the D-ring 18 will soon come into contact with the restraining wall 10, whereby the progress of the entanglement is prevented. The movement of the D-ring 18 toward the operating portion 9 is also prevented by the restraining wall 10. The D-ring 18 is thus prevented from touching and pushing back the operating portion 9 in the pull-down direction Do.

Next, in a case where the D-ring 18 lies at a position where the axis thereof coincides with C1 or C2 and has an entanglement pose with the turn-around angle β around the hook line of the hook portion 4 and the axis line of the engage pin 11, as the turn-around angle β approaches 90°, a force for moving the D-ring 18 toward the operating portion 9, which is exerted at the time of the entanglement by both or either of the curved portions thereof, increases. There will be now considered a case where the D-ring 18 is moved to a position where the axis thereof coincides with C3 indicated by a dashed line. In that case, however, of an entanglement force R exerted to the hook portion 4 on the side of a preceding part 18a due to an entanglement in a direction G indicated by an arrow, a guiding component R1 for moving the D-ring 18 toward the operating portion 9 is small. A guiding component of the entanglement force R exerted on the side of a following part 18b for moving the D-ring 18 toward the operating portion 9 is almost zero.

Thus, the D-ring 18 is hardly moved toward the operating portion 9 and thereby prevented from pushing back the operating portion 9 in the pull-down direction Do. In other words, the restraining window 15, defined by the restraining wall 10, restricts the movement of the D-ring 18 within a range shown by the connection part 14 where the D-ring 18 is connected to the hook portion 4. Note that, even if the D-ring 18 is moved toward the operating portion 9 or the D-ring 18 is turned over to be in contact with the operating portion 9 without the entanglement force, the D-ring 18 is free from pushing back the operating portion 9 in the pull-down direction Do. This is because the D-ring 18 is free from receiving a force of constraint exerted between the D-ring 18 and the hook portion 4.

Thus, the restraining wall 10 corresponds to the first means for restricting the movement of the connection object so that it cannot be allowed to come into contact with the operating portion by restricting a range of movement of the connection object in the hook portion of the above-described snap hook.

In the illustrated example, the end 4a of the hook portion 4 and the end 11a of the engage pin 11 (FIG. 4 and FIG. 6) are configured to make contact with each other in a manner such that a cleavage line therebetween inclines with respect to a direction perpendicular to an axis continuous with the hook line and the axis line thereof, from the outer circumference to the inner circumference, toward the connection part 14 of the hook portion 4, as shown in FIG. 1. With such a configuration that the end 4a of the hook portion 4 and the end 11a of the engage pin 11 make contact with each other so as to form a cleavage line therebetween inclining with respect to the direction perpendicular to their axes toward the connection part 14 of the hook portion 4, even when an outward load is exerted on the end 11a of the engage pin 11 by the connection object 13 such as the D-ring 18, such a load is received by the end 4a of the hook portion 4.

Moreover, an opened area, opened by the retraction of the engage pin 11, between the ends of the engage pin 11 and the hook portion 4 is in communication with the restraining window 15 through a passage inclined toward the connection part 14 of the hook portion 4. Thus, the restraining window 15 comes closer to the connection part 14 of the hook portion 4, thereby allowing the connection object 13 to enter or exit the connection part 14. Thus, the movement restriction of the connection object 13 can be sufficiently achieved while avoiding the need to enlarge the restraining window 15 on the side of the base 3 of the main body 7.

The restraining wall 10 includes a slit 21 provided to be separated from the sleeve portion 5 and formed between an end 5a and a base 5b of the sleeve portion 5. As described above, the restraining wall 10 extends between the sleeve portion 5 and the hook portion 4 from the base 5b toward the connection part 14 of the hook portion 4. The restraining wall 10 serves to restrict the movement of the connection object 13 such as the D-ring 18 after being connected. By forming the slit 21 between the end 5a and the base 5b of the sleeve portion 5 so as to separate the restraining wall 10 from the sleeve portion 5, the restraining wall 10 will not disturb the bending of the sleeve portion 5, in which the engage pin 11 is encased at an undisturbed position closer to the end of the hook portion 4, performed so as to make the end 5a opposed to the end 4a of the hook portion 4.

This is done for the case where the main body 7 is integrally formed using a mold. This is because if the end 5a and the end 4a are opposed to each other on the same axis line from the beginning, the engage pin 11 cannot be attached to the sleeve portion 5 afterward. Thus, in order for the engage pin 11 to be attached afterward, the end 5a and the end 4a are molded in a staggered fashion so as to prevent the ends 5a and 4a from being opposed to each other. As a result, when the sleeve portion 5 is bended so as to make the ends 5a and 4a opposed to each other after the engage pin 11 is encased in the sleeve portion 5 together with the spring 12, the sleeve portion 5 can be easily bended independently without the connection with the restraining wall 10.

However, such staggering may be achieved on the side of the hook portion 4. The slit 21 can be eliminated if such staggering is achieved by twisting the hook portion 4 over a range from the connection part 14 to the end 4a thereof. The slit 21 can also be eliminated if the main body 7 is fabricated by molding it as halves of a front side and a back side and coupling the halves so as to interpose the engage pin 11 and the spring 12 therebetween.

As shown in FIG. 1, the main body 7 forms an approximately elliptic symmetrical contour, when viewed from the front or the back, by the base 3, the hook portion 4, the sleeve portion 5, and the engage pin 11. Corresponding to the closed position of the engage pin 11, the operating portion 9 is located between a central largest width portion S in the contour of the main body and the base 3. Accordingly, even if the connection object 13 such as the D-ring 18 touches and pushes back the operating portion 9 for some reason, the operating portion 9 is moved toward the base 3 at which a width in the contour of the main body 7 is smaller. Thus, the operating portion 9 is easy to move away from the connection object 13 which touches and pushes back the operating portion 9.

In the illustrated example, the elliptic contour of the main body 7 is defined so that the base 3 side and the connection part 14 side correspond to focus positions having a smaller curvature in the direction of the length thereof. Accordingly, the base 3 and the connection part 14 respectively have a width distinctly smaller than that of the central largest width portion S. Also, the operating portion 9 is easier to move away from the connection object 13, which touches and pushes back the operating portion 9. Along with restricting the connection part 14, over which the connection object 13 is joined to the hook portion 4, within a smaller range, a centripetal tendency toward the center, due to the tension exerted between the connection object 13 and the leash 16, is increased. Consequently, the likelihood of generating the entanglement caused by the twist is reduced.

Further details will now be described. As shown in FIG. 1, FIG. 2, and FIG. 3, the restraining wall 10 has a thickness smaller than that of the surrounding thereof as illustrated at the center of FIG. 2 and FIG. 3 as viewed from the side, showing slopes 22 formed from both of the front and back sides of the base 3, the hook portion 4, and the sleeve portion 5. As shown in FIG. 2, FIG. 4, and FIG. 5, the main body 7 is formed so as to reduce its thickness from the base 3 toward the connection part 14 of the hook portion 4. The thickness of the restraining wall 10 is set to be about one-third of that of the connection part 14 as viewed from the side. This achieves strength sufficient for bearing the entanglement force by the connection object 13 such as the D-ring 18, while suppressing an increase in weight and size of the main body 7 due to the restraining wall 10.

Further, as shown in FIG. 1 and FIG. 3, the engage pin 11 includes: the body 11b encased in the sleeve portion 5; and ribs 11c and 11d extending from the body 11b so as to be fitted in the sliding slits 8a and 8b formed on the inner side and outer side of the sleeve portion 5. These are provided to increase the bending strength of the engage pin 11 in the direction of the length thereof. Thus, even if tension is exerted on the engage pin 11 by the connection object 13 such as the D-ring 18, strength guarantee can be achieved more easily due to the above-described tension receiving performed in cooperation with the hook portion 4 and the sufficient bending strength of the engage pin 11. As shown in FIG. 1 and FIG. 6, the operating portion 9 is integrally molded on a lower portion of the outer rib 11d of the engage pin 11 so as to extrude downwardly from the lower end of the engage pin 11. The operating portion 9 is thereby located more easily at a position between the central largest width portion S of the main body 7 and the base 3, i.e., on the lower side.

As shown in FIG. 3 and FIG. 4, the operating portion 9 is formed to have a curved shape in the direction of the length of the main body 7 shown in FIG. 1 and FIG. 6 and in the front and back directions shown in FIG. 3 so that the back surface thereof, integrally connected to the rib 11d, conforms to the contour of the main body 7. Consequently, the proximity of the operating portion 9 to the main body 7 is increased. The front surface of the operating portion 9 is formed to have an ellipsoid shape, small bulk, and a flat overhang shape. By doing so, while keeping an adequate handhold for operations, the operating portion 9 is made easier to avoid being hitched by the connection object 13 such as the D-ring 18 due to the entanglement thereof, together with the positional conditions with respect to the main body 7. In order to obtain a better handhold for operations, the surface of the operating portion 9 can be provided with a plurality of projecting portions for hitching or a concave-convex portion made of protrusions and recesses.

By appropriately selecting a protrusion level, an arrangement density, and a configuration of the concave-convex portion, it becomes possible to prevent the connection object 13 from easily hitching the concave-convex portion. For the sake of this, the protrusion level of the projecting portion or the protrusion is preferably set to be small, and an interval between the projecting portions or the protrusions is preferably set to be smaller than an interval into which the connection object 13 can enter and cause hitching. Moreover, as long as the recess is smaller than the interval into which the connection object 13 can enter and cause hitching, the arrangement density of the projecting portions or the protrusions is of no concern. The restraining wall 10 may be further extended toward the connection part 14 as indicated by an imaginary line in FIG. 1 in order to further restrict the movement of the connection object 13, unless the restraining wall 10 does not block the connection object 13 from entering or exiting the connection part 14 through the opening 6.

As described above, in the snap hook 100 of the present embodiment, even if the D-ring 18 is in contact with the operating portion 9, the operating portion 9 moves toward the base 3 of the main body 7. Thus, the contact between the operating portion 9 and the D-ring 18 is eliminated before leading to an unexpected detachment of the D-ring 18.

### Second Embodiment

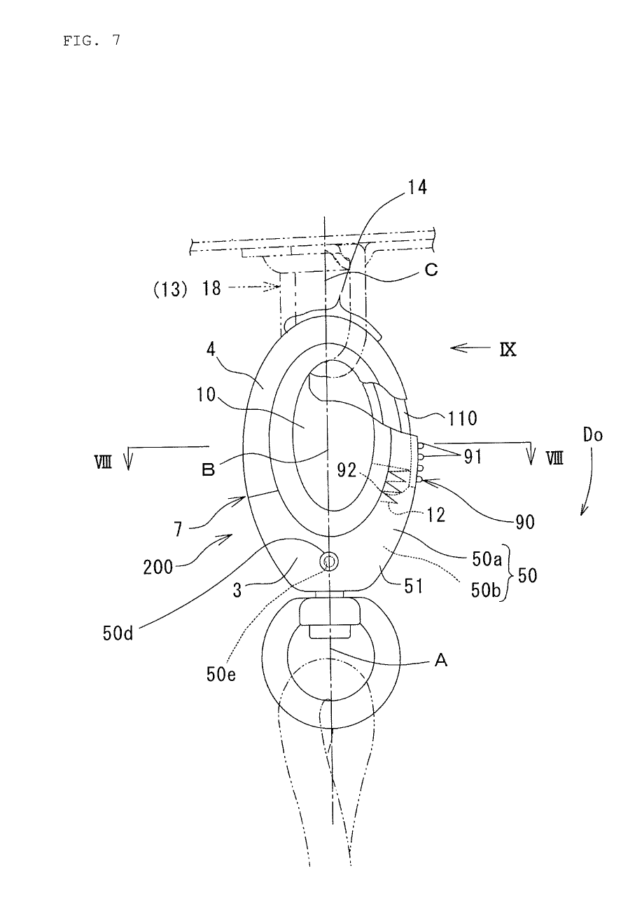

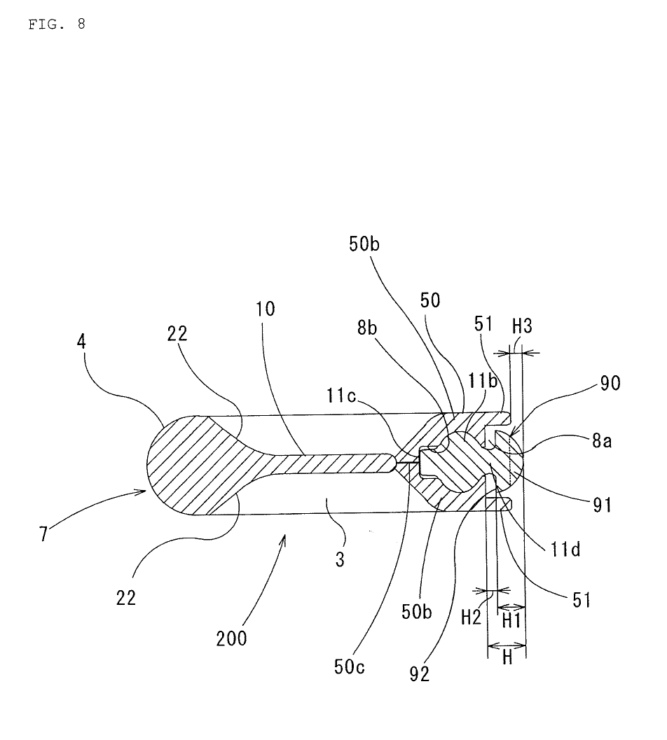

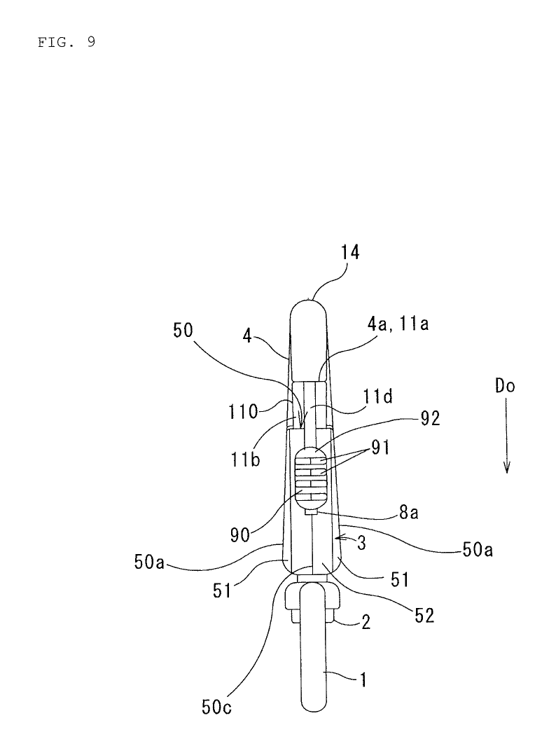

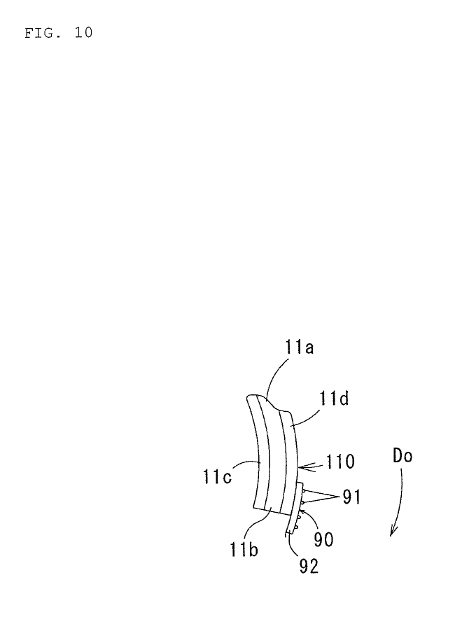

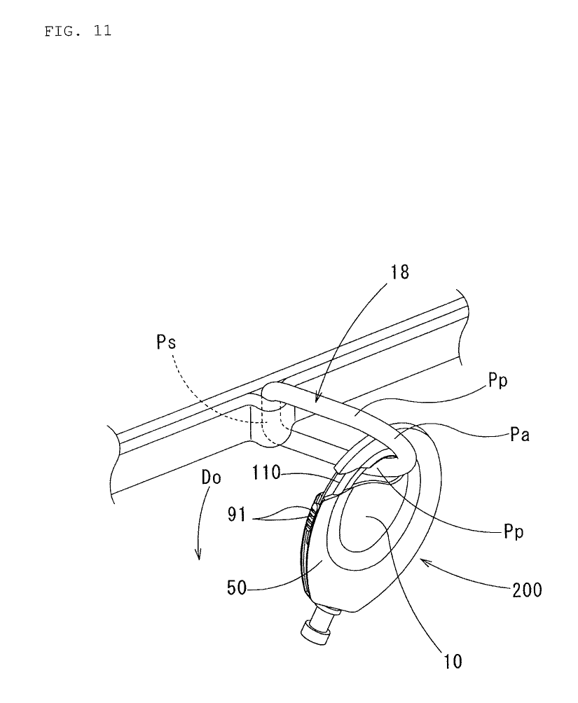

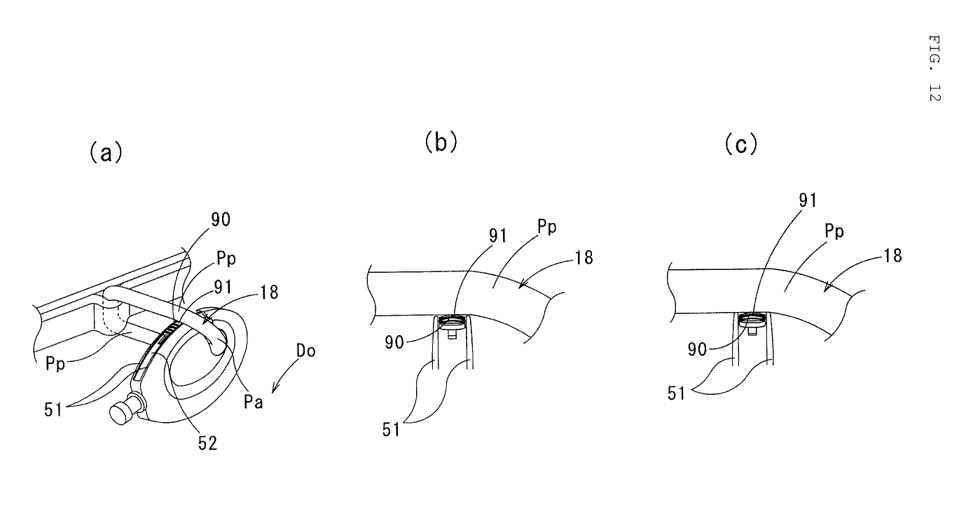

A snap hook for an animal—according to a second embodiment of the present invention will be described below with reference to FIG. 7, FIG. 8, FIG. 9, FIG. 10, FIG. 11, and FIG. 12. As shown in FIG. 7, a snap hook for an animal (hereinafter referred to as a “snap hook”) 200 according to the present embodiment differs from the snap hook 100 (FIG. 1) according to the above-described first embodiment in that the engage pin 11 is replaced with an engage pin 110 and that the sleeve portion 5 is replaced with a sleeve portion 50. The engage pin 110 includes an operating portion 90 (will be described later with reference to FIG. 10). The operating portion 90 has a predetermined number of ridges (notches) 91. The ridges 91 of the operating portion 90 are exposed to the outside from the sleeve portion 50 through the slit 8a. A description below will focus on the features specific to the present embodiment.

Firstly, with reference to FIG. 10, the configuration of the engage pin 110 will be described. The engage pin 110 differs from the engage pin 11 (FIG. 6) in that the operating portion 9 is replaced with the operating portion 90. The operating portion 90 includes a body 92 (FIG. 9) of an approximately oval shape as viewed from the above. The body 92 is provided with a predetermined number (in FIG. 10, four) of ridges 91. The operating portion 90 is exposed to the outside at the portion of the ridges 91. The ridges 91 are provided to serve as a handhold for users operating the operating portion 90. The ridges 91 are formed in a direction substantially perpendicular to a direction in which the operating portion 90 is moved.

The ridge 91 has what is called a flat plate shape. An interval between adjacent ridges 91, i.e., an interval between streak-like projecting portions formed by the ridges 91 is smaller than a width of the connection object 13 (in the present embodiment, the D-ring 18 (FIG. 7)). Even if another object such as the D-ring 18 or an object having a width or thickness about equal to the D-ring 18 is in contact with the operating portion 90, such another object is prevented from entering into a portion between the adjacent ridges 91. Thus, the ridges 91 are prevented from being hitched by another object such as the D-ring 18.

The ridges 91 generally refer to those obtained by the process of notching (cutting). In practice, however, the ridges 91 are formed using a mold simultaneously when the engage pin 110 and the operating portion 90 are integrally molded. The ridge 91 may have any shape other than the flat plate shape as in the present example as long as it has, on an outer surface faced outwardly by the body 92 of the operating portion 90, i.e., on a front surface of an operation face, a shape that can be used as a handhold for an opening operation performed by a user or a shape capable of preventing a slip. Specific examples thereof include those provided with various protrusions and recesses, such as pyramid-shaped independent projections known as knurling and arranged in a matrix.

The ridge 91, forming a protrusion as in the present example, is advantageous in that it can be easily formed with a two-split mold which opens up to either side. The protrusion formed in the ridge 91 has an upper end formed in a rounded shape in the moving direction of the operating portion 90 as shown in FIG. 7. Consequently, the likelihood of being hitched by the D-ring as well as another passing object approaching from the hook portion 4 side can be further reduced. At the same time, such a shape prevents a slip since a settlement on the protrusions and recesses is obtained due to resiliency by a pressing action at the time of an intended opening operation.

Moreover, as shown in FIG. 8, the projecting portion in the ridge 91 has a dome-like curved shape having a largest height at its center in a direction perpendicular to the moving direction of the operating portion 90 and a reduced height toward the both sides. The projecting portion is exposed to the outside from the sleeve portion 50. Consequently, the resilient pressing action during an opening operation and the resultant settlement are effectively obtained intensively at the center of the projecting portion of the ridge 91 at which the height is largest. Thus, the opening operation can be performed smoothly with less slippage. Furthermore, with the employment of a configuration such that the projecting portion in the ridge 91 has a reduced height toward the both ends thereof, or more preferably a configuration such that the exposed height of the projecting portion equals zero at the both ends thereof, it becomes possible to reduce a likelihood of the ridges 91 being caught by the D-ring, a fabric or string of a cloth worn around the torso of a dog or the like being connected, or another passing object provided with protrusions and recesses.

Next, with reference to FIG. 7, FIG. 8, and FIG. 9, the configuration of the sleeve portion 50 will be described. As shown in FIG. 8, the sleeve portion 50 encases the engage pin 110 in a manner such that only the ridges 91 are exposed from the sleeve portion 50 by a predetermined height H3 (hereinafter referred to as the “ridge portion exposed height H3”). In other words, the sleeve portion 50 covers the body 92 of the operating portion 90. For the sake of this, the sleeve portion 50 may have a greater length in the widthwise direction of the snap hook 200 (the direction along the minor axis of the approximately elliptic main body 7) as compared to that of the sleeve portion 5 (FIG. 1). A relationship between the operating portion projecting height H and the operating portion exposed height H1 is as shown in FIG. 8.

Specifically, as shown in FIG. 8 and FIG. 9, the sleeve portion 50 includes a pair of side walls 51 opposed to each other at both sides of a peripheral wall 52, at which the slit 8a is formed, with slits having a greater width than that of the slit 8a. The side walls 51 have a height sufficient to hide the body 92 of the operating portion 90 from both sides thereof. The side walls 51 are provided so that only the ridges 91 are exposed to the outside. Furthermore, as shown in FIG. 7 and FIG. 8, the sleeve portion 50 is configured by integrating together a portion 50a integrally formed with the main body 7 and a divided body 50b formed separately from the main body 7 with the engage pin 110 and the spring 12 interposed therebetween. In the sleeve portion 50, the above-described sliding slit 8a, which faces the contour of the main body 7 formed by the sleeve portion 50 and the hook portion 4 arranged side by side, is formed at an interface 50c between the integrally-formed portion 50a and the divided body 50b.

Consequently, the employment of a method such that the engage pin 110 and the spring 12 are encased in the sleeve portion 50 from the side of the hook portion 4 can be avoided, whereby the need to separate the restraining wall 10 from the sleeve portion 50 by means of the slit 21 shown in the first embodiment is eliminated. As shown in FIG. 7, the integration of the divided body 50b with the integrally-formed portion 50a is achieved by fitting a fastening pin 50d integrally molded with the integrally-formed portion 50a into a connection hole 50e formed in the divided body 50b and by swaging a tip portion thereof for fastening. However, the method is not limited to this. Another method such as screwing or welding connection may be employed.

In the snap hook 200 having the above-described configuration, while the side walls 51 cover the body 92 of the operating portion 90, the ridges 91 are exposed in order to serve as a handhold for a user operating the operating portion 90. That is, both sides of the operating portion 90, except for the above-mentioned handhold for operations, are covered by the side walls 51 formed in the sleeve portion 50 beyond its range of motion. Further, the movement of the D-ring 18 is restricted by the restraining wall 10, as with the first embodiment described above. In contrast to the snap hook 100 according to the first embodiment, the operating portion 90 in the snap hook 200 will never come into contact with the D-ring 18 owing to the existence of the side walls 51. This feature will be described below with reference to FIG. 1, FIG. 11, and FIG. 12.

FIG. 11 shows an example of a positional relationship between the D-ring 18 and the operating portion 90, in a state where the snap hook 200 is joined to the D-ring 18. As illustrated in this figure, the D-ring 18 includes: a straight portion Ps; an arc portion Pa opposed to the straight portion Ps; and two parallel portions Pp parallel to each other. These portions together form the shape of the letter “D.” The straight portion Ps of the D-ring 18 is stitched in and fastened to a collar or the like. As described in detail in the first embodiment, the movement of the D-ring 18 is restricted by the restraining wall 10. In other words, in order to prevent one of the two parallel portions Pp of the D-ring 18 from touching the ridges 91, the restraining wall 10 restricts the position of the other of the parallel portions Pp in the connection part 14. Specifically, the restraining wall 10 is provided in a manner such that the distance between the two parallel portions Pp becomes greater than the maximum distance between the contour of the restraining window 15 and the ridges 91. The parallel portions Pp are thereby prevented from being in contact with the ridges 91. Therefore, a portion of the D-ring 18 that may approach the operating portion 90 is the arc portion Pa.

To be more precise, the portion of the D-ring 18 that may approach the operating portion 90 is the inner circumferential portion of the arc portion Pa. Although the D-ring 18 can approach the operating portion 90, it is prevented from touching the ridges 91. In other words, the inner circumferential portion of the arc portion Pa would lie astride the side walls 51, thereby being prevented from touching the ridges 91, due to the small curvature of the D-ring 18 as mentioned above. Moreover, depending on the positional relationship between the D-ring 18 and the snap hook 200, the inner periphery of the arc portion Pa in the D-ring 18 may be further away from the ridges 91.

As described above, in a case where entanglement occurs between the D-ring 18 and the hook portion 4, the D-ring 18 is prevented from touching the operating portion 90 (the ridges 91), due mainly to the restraining wall 10 and the side walls 51. Thus, the operating portion 90 (the ridges 19) is free from being pushed back by the D-ring 18. In other words, the side walls 51 correspond to the above-described second means provided in the vicinity of the operating portion for receiving the connection object so as to prevent the connection object from coming into contact with the operating portion.

Also in a case where no entanglement occurs, the operating portion 90 (the ridges 91) is free from being pushed back by the D-ring 18, as described in the first embodiment. In other words, in a case where the axis A of the base ring 1, the axis B of the hook portion 4, and the axis C of the D-ring 18 are approximately aligned with one another due to the pulling of the leash 16 or the like, a twist generated between the leash 16 or the like and the D-ring 18 or the like can be cancelled out by rotation between the base ring 1 and the main body 7 about the stem 2. Thus, no entanglement force is generated between the D-ring 18 and the hook portion 4. That is, the D-ring 18 will never push back the operating portion 90 in the pull-down direction Do, even if the D-ring 18 is moved toward the operating portion 90 or turned over to touch the operating portion 90.

In the snap hook 200, the D-ring 18 is prevented from touching the operating portion 90 (the ridges 91) as described above, regardless of the presence or absence of an entanglement caused by an unexpected action of an animal. An unexpected detachment is thus prevented.

However, depending on an amount of time in use or rough usage, a change in the shape of the snap hook 200 (dimensional relationships among the parts thereof) may occur due to the material deterioration thereof, wear thereof, and the like. Specifically, as shown in FIG. 12, unconnected one of the parallel portions Pp of the D-ring 18 (FIG. 12(a)), which is normally prevented from touching the ridges 91, may come to touch the ridges 91 (FIG. 12(b)). In such a case, the ridge portion exposed height H3 (FIG. 8) of the ridge 91 possibly serves as a handhold for the parallel portion Pp. The parallel portion Pp firstly touches and presses the ridges 91 inwardly. A predetermined clearance C (not shown) exists between the engage pin 110 provided with the operating portion 90 and the inner wall of the sleeve portion 50 inside which the engage pin 110 is encased.

Therefore, in a case where the clearance C is greater than the ridge portion exposed height H3, the pressing motion of the parallel portion Pp on the ridges 91 is absorbed by the clearance C (FIG. 12(c)). As a result, the parallel portion Pp cannot use the ridges 91 as the handhold. The operating portion 90 is thus free from being pushed down in the pull-down direction Do.

In a case where the clearance C is smaller than the ridge portion exposed height H3, the ridges 91, depending on a level of the difference therebetween, may be insufficient to serve as the handhold for the parallel portion Pp. Thus, the operating portion 90 is free from being pushed down in the pull-down direction Do. In a case where the ridges 91 can serve as the handhold, once the parallel portion Pp pushes down the operating portion 90 by a predetermined distance (hereinafter referred to as a “move away distance”), the ridges 91 move away from the parallel portion Pp in a manner similar to that of the above-described first embodiment. The engage pin 110 is thus returned to its original position. Note however that the ridge portion exposed height H3 and the width (length in the direction along the major axis of the main body 7) of the ridges 91 of the present embodiment are about one several-tenths of those of the operating portion 9 in the first embodiment. Thus, the move away distance thereof is likewise small. As a matter of course, the move away distance is proportional to the distance by which the operating portion is pushed back. In a case where the parallel portion Pp is intermittently in contact with each of the ridges 91 arranged parallel to each other, the operating portion 90 moves toward its original position every time the parallel portion Pp climbs over the ridge 91 in contact.

In the present embodiment, the ridges 91 of the operating portion 90 are exposed from the sleeve portion 50 by an amount equal to the ridge portion exposed height H3. However, the entire operating portion 90 (the body 92 and the ridges 91) may be covered completely by the sleeve portion 50 (the ridge portion exposed height H3≦0). This configuration eliminates the possibility that the D-ring 18 comes into contact with the ridges 91 and therefore eliminates an unexpected detachment between the snap hook and the D-ring. Note that this type of snap hook is less easy-to-operate, in comparison to the case where the ridges 91 are exposed from the sleeve portion 50. Users, however, can operate the operating portion 90 by the ball of a finger or a nail.

### Third Embodiment

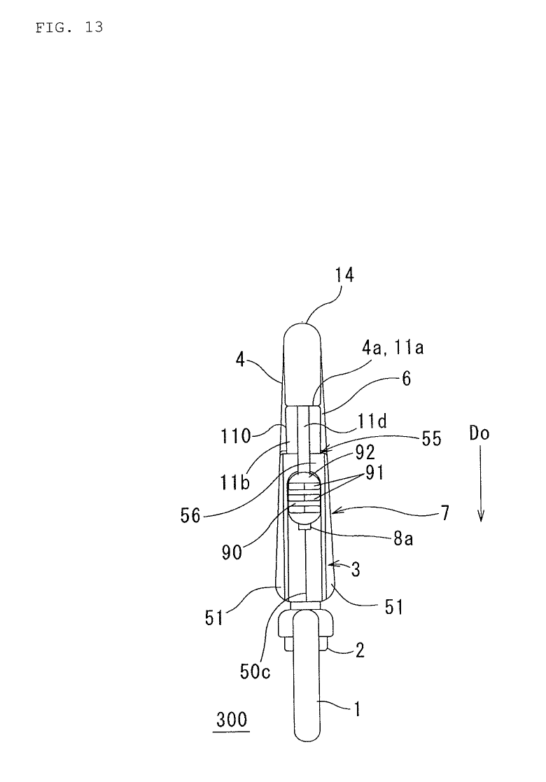

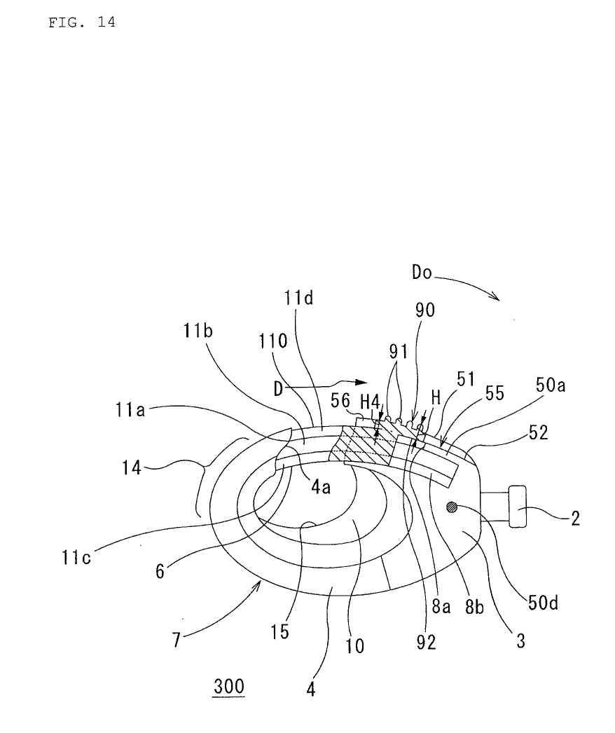

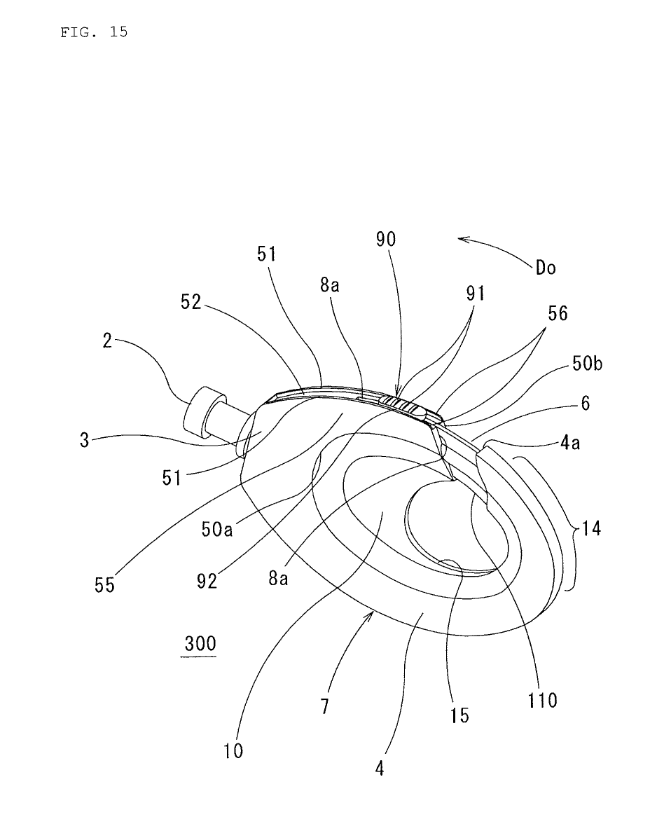

Specific features of a snap hook for an animal according to a third embodiment of the present invention will be described below with reference to FIG. 13, FIG. 14, and FIG. 15. A snap hook for an animal (hereinafter referred to as a “snap hook”) 300 according to the present embodiment is obtained by further improving the snap hook 200 of the second embodiment. In the snap hook 200 according to the second embodiment, in order to make the ridges 91 exposed to the outside (the ridge portion exposed height H3), the operating portion 90 is covered by the side walls 51 of the sleeve portion 50 from the both sides thereof. In other words, the operating portion 90 and the ridges 91 are opened toward the hook portion 4.

Thus, during an actual use when an animal is led or held, there exists a possibility that any kind of another passing object other than the D-ring, such as a fabric or string of a cloth worn around the torso of a dog or the like being connected, or an object provided with protrusions and recesses, moves in the pull-down direction Do from the side of the hook portion 4 toward the operating portion 90, and an end of the operating portion 90 on the side of the hook portion 4 is hitched by such an object under various conditions. Due to the existence of such hitching, the operating portion 90 receives, from the end side thereof closer to the hook portion 4, a force for pushing it back toward the body 92, i.e., a force of an operation in the opening direction. As a result, the opening 6 may be exposed unexpectedly by any chance.

As a countermeasure against this problem, the snap hook 300 includes a sleeve portion 55 instead of the sleeve portion 50 in the snap hook 200 of the second embodiment. The sleeve portion 55 includes, on the side of the operating portion 90 closer to the hook portion 4, a guard portion 56 for preventing an unexpected hitching force from being exerted on the body 92 and the ridges 91 of the operating portion 90 from the hook portion 4 side. The guard portion 56 extrudes more in the outward direction than at least the end of the body 92 of the operating portion 90 closer to the hook portion 4 with respect to the operating portion 90 at a position corresponding to the closed position of the engage pin 110.

Specifically, as shown in FIG. 13, FIG. 14, and FIG. 15, the guard portion 56 is located in a portion of the body 92 closer to the hook portion 4 so as to lie next to a ridge lower end height H4, which is a height from the sleeve portion 55 in the body 92 of the operating portion 90 to the lower end of the ridge 91, as shown in FIG. 14. In other words, the sleeve portion 55 covers the body 92 of the operating portion 90. For the sake of this, the sleeve portion 55 may have a greater length in the widthwise direction of the snap hook 300 (the direction along the minor axis of the approximately elliptic main body 7) as compared to that of the sleeve portion 5 (FIG. 1). Accordingly, as shown in FIG. 14, even if another object such as the D-ring or the like approaches toward the operating portion 90 from the hook portion 4 side in a direction parallel to the pull-down direction Do as indicated by an arrow D, such another object may be received by the guard portion 56 or moved away in the outward direction by the guard portion 56. In other words, such another object is prevented from coming into contact with a free end (the connection part 14 side) of the body 92 of the operating portion 90.

Thus, it is possible to avoid a condition such that the body 92 of the operating portion 90 is hitched by another object and the operating portion 90 is thereby moved in the pull-down direction Do. Even if such another object, moved away in the outward direction from the guard portion 56, reaches the ridges 91 exposed from the sleeve portion 55, such another object, touching and passing by the ridges 91, hardly induces a settlement action due to resiliency, which is obtained by a pressing action as in an intended operation. Thus, such another object can be slid through without hitching the ridges 91, thereby preventing unexpected exposure of the opening 6. Also, the guard portion 56 does not particularly inhibit an intended opening operation accompanied by a settlement due to resiliency obtained by a pressing action by the ball of a finger.

The other elements in the configuration of the present embodiment are not notably different from those of the second embodiment. However, as shown in FIG. 13 and FIG. 15, the guard portions 56 are integrally and continuously formed with the side walls 51, which cover the body 92 of the operating portion 90 in the sleeve portion 55 from the both sides thereof. This makes it easier to prevent the body 92 and the ridges 91 of the operating portion 90 from being hitched by the D-ring or another object other than the D-ring approaching from the hook portion 4 side. Although the guard portions 56 are provided so as to be away toward the either side by an amount corresponding to a width of the sliding slit 8a, the guard portions 56 may be provided without a gap therebetween. Such a configuration can also prevent a hitching force from being exerted, from the hook portion 4 side, on the body 92 or the ridges 91 through the gap between the guard portions 56.

The guard portion 56 is slanted so that the extruding height thereof in the outward direction increases from the hook portion 4 side toward the ridges 91 side in the sleeve portion 55. Owing to this configuration, even if the operating portion 90 is touched and passed by any kind of object, including the D-ring and other objects such as a fabric or string of a cloth worn around the torso of a dog or the like being connected and objects provided with protrusions and recesses, from the hook portion 4 side as indicated by the arrow, such an object can be moved away more easily in the outward direction by the guard portion 56. Thus, it is possible to reduce the possibility that such another object received by the guard portion 56 reaches the ridges 91.

### Fourth Embodiment

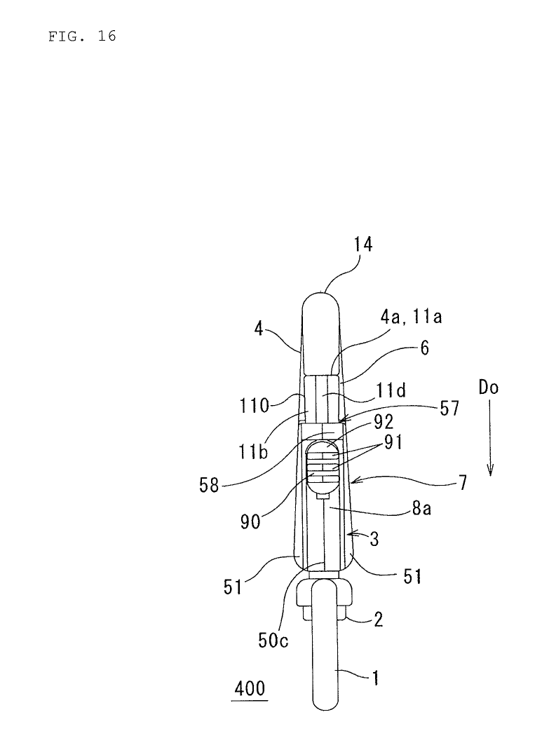

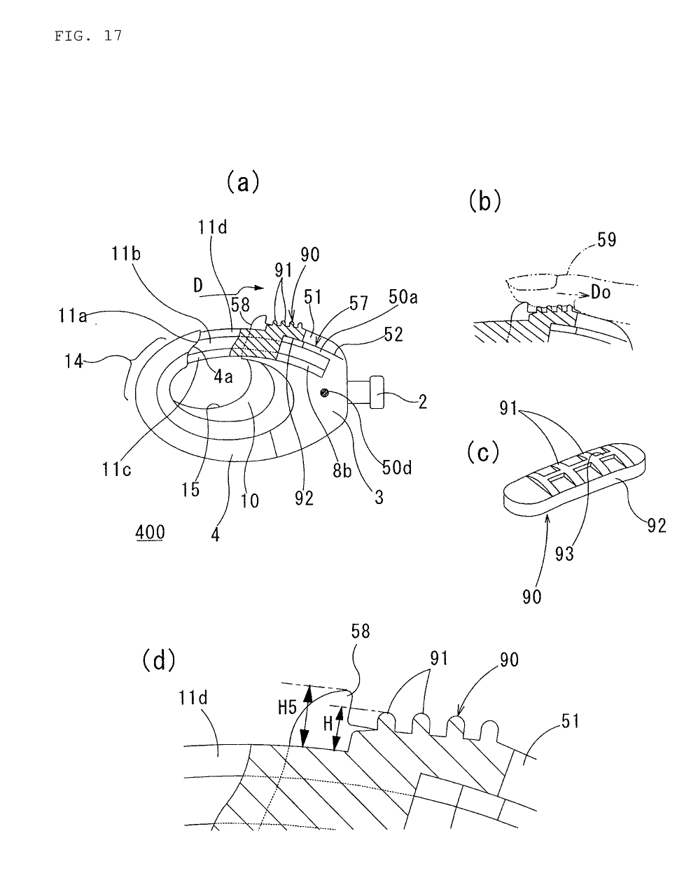

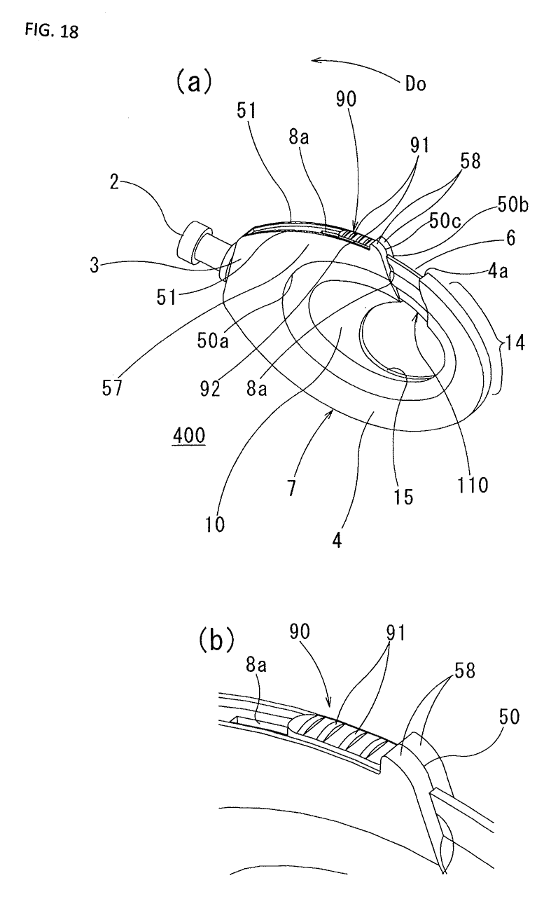

Specific features of a snap hook for an animal according to a fourth embodiment of the present invention will be described below with reference to FIG. 16, FIG. 17, and FIG. 18. A snap hook for an animal (hereinafter referred to as a “snap hook”) 400 according to the present embodiment includes a sleeve portion 57 obtained by further improving the snap hook 300 according to the third embodiment. The sleeve portion 57 includes a guard portion 58 for preventing an unexpected hitching force from being exerted from the hook portion 4 side on the body 92 of the operating portion 90 as well as the ridges 91. With respect to the operating portion 90 at a position corresponding to the closed position of the engage pin 110, the guard portion 58, on the side of the operating portion 90 closer to the hook portion 4, extrudes more in the outward direction than at least a portion of the ridges 91 formed in the body 92 of the operating portion 90, which is closer to the hook portion 4.

With reference to FIG. 17 and FIG. 18, the configuration and functions of the guard portion 58 will be described. As can be seen from FIG. 17(a) and FIG. 17(d), the guard portion 58 is provided so as to project from the sleeve portion 57 in the portion of the ridges 91 formed in the body 92 of the operating portion 90 by a predetermined height H5 (hereinafter referred to as the “guard portion height H5”), which is greater than the operating portion projecting height H. Note that the guard portion height H5> the ridge lower end height H4 (FIG. 14). As shown in FIG. 17(d) and FIG. 18(b), the guard portion 58 increases its extruding height (the guard portion height H5) in the outward direction from the hook portion 4 side toward the ridges 91 side in the sleeve portion 57. More preferably, the guard portion 58 is positioned in a portion of the body 92 closer to the hook portion 4 so as to extend beyond the projecting portions of the ridges 91 as shown in FIG. 16, FIG. 17, and FIG. 18.

Thus, as shown in FIG. 17(a), even when the operating portion 90 is touched and passed by the D-ring or another object other than the D-ring from the hook portion 4 side as indicated by the arrow D, the guard portion 58 can receive it or make it move away in the outward direction from the guard portion 58. As can be seen from the FIG. 18(b), the passing object moves along the slanted surface of the guard portion 58. Thus, such an object is moved away along a height equal to or greater than the exposed height of the ridges 91 on the side of the hook portion 4, more specifically, along a height over the exposed height of the ridges 91 on the side of the hook portion 4.

As a result, while preventing the occurrence of hitching in the body 92 of the operating portion 90, another object, moved away in the outward direction from the guard portion 58, can be prevented from reaching the body 92 of the operating portion 90 as well as a portion of the ridges 91 closer to the hook portion 4, exposed from the sleeve portion 57. Furthermore, even if hitching occurs in a portion of the ridges 91, which is opposite to the hook portion side, it can be suppressed to a level such that they slightly touch and pass each other. Such passing by another object hardly induces a settlement action due to resiliency, which is obtained by a pressing action as in an intended operation. Thus, such another object can be slid through smoothly without hitching the ridges 91, thereby reliably avoiding unexpected exposure of the opening 6. In other words, in comparison with the guard portion 56, the guard portion 58 can protect the operating portion 90 from another object similarly or better.

Moreover, the guard portion 58 is located in a portion of the body 92 closer to the hook portion 4 so as to extend beyond the exposed height, from the sleeve portion 57, of the ridges 91 formed in the body 92 of the operating portion 90. However, as indicated by an imaginary line in FIG. 17 (b), the guard portion 58 will not particularly inhibit a settlement of a finger 59 obtained when the finger 59 is pressed against the ridges 91. Such a settlement is obtained by the finger 59 resiliently coming in between the ridges 91. Therefore, a force of an opening operation in the direction of arrow Do indicated by the imaginary line in FIG. 17(b) can be sufficiently exerted on the operating portion 90. Consequently, the opening operation can be performed smoothly without a slip. In some cases, the closure of the sliding slit 8a by the guard portion 58 can be achieved by extending either one of the integrally-formed portion 50a and the divided body 50b. Note that the smaller the pitch between the projecting portions of the ridges 91, the more the degree of slipperiness increases with respect to the D-ring, a cloth or string for an animal, and other objects with protrusions and recesses, with which a resilient pressing action as in the case of a finger does not occur. For an operation by a finger performing a resilient pressing action, however, a function to prevent a slip or an ability to be hitched is not so deteriorated. Thus, the operability thereof is not degraded.

However, as shown in FIG. 17(c), the flat-plate-shaped ridges 91 may be connected to each other at the center of the projecting portions in the horizontal direction with a rib 93 extending in a direction in which an operation is performed. By doing so, it is possible to further increase the degree of slipperiness with respect to the D-ring, a cloth or string for an animal, or other objects with protrusions and recesses. Also for an operation by a finger performing a resilient pressing action, a function to prevent a slip or an ability to be hitched is not so deteriorated. Thus, the operability thereof is not degraded. For the sake of this, the rib 93 preferably has a height about equal to or slightly smaller than the height of the projecting portion.

Furthermore, the portion of the ridges 91 in the operating portion 90 is configured, either together with the body 92 as shown in FIG. 17 or by itself (which case is not shown), so that a height thereof and also an exposed height thereof from the sleeve portion 57 increase from the side of the hook portion 4 toward the side opposite to the hook portion 4. Thus, as shown in FIG. 17(b), when performing an opening operation in the direction of arrow Do by pressing the finger 59 on the ridges 91, which is accompanied by a settlement due to resiliency, the operating portion 90 can receive a stronger hitched force by the finger 59 coming in between the ridges 91, due to the slanted state generated by the above-described change in the exposed height. Thus, the force of the opening operation in the direction of arrow Do can be exerted on the operating portion 90 more reliably. Thus, the opening operation can be performed further smoothly and reliably without a slip. Additionally, it is also possible to avoid unexpected exposure of the opening 6 due to being hitched by the D-ring or another object.

### Fifth Embodiment

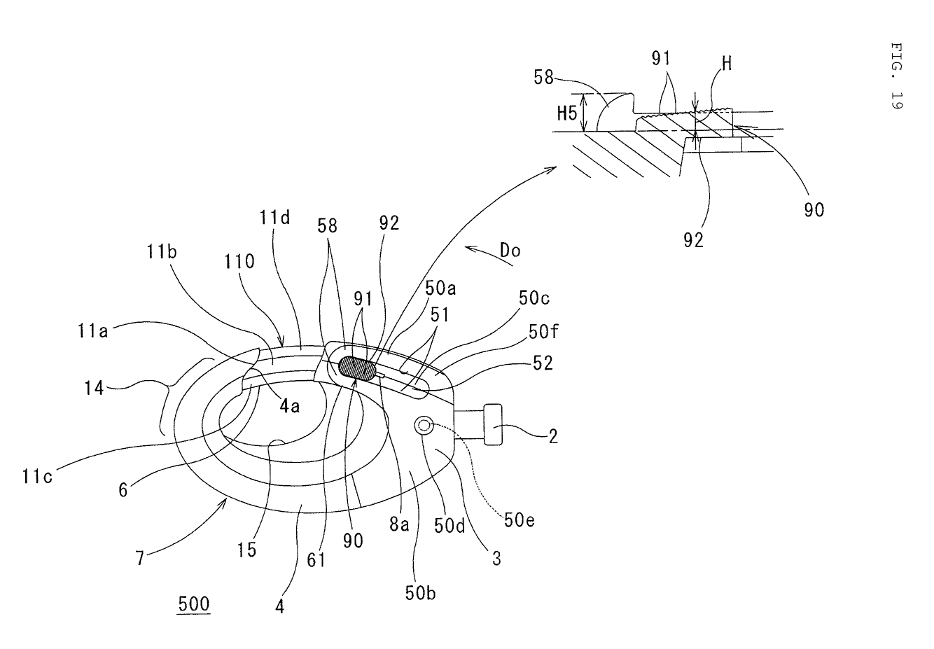

Specific features of a snap hook for an animal according to a fifth embodiment of the present invention will be described below with reference to FIG. 19. A snap hook for an animal (hereinafter referred to as a “snap hook”) 500 according to the present embodiment includes a sleeve portion 61 obtained by further improving the snap hook 400 of the fourth embodiment. The sleeve portion 61 is formed by integrating together the portion 50a integrally formed with the main body 7 and the divided body 50b formed separately from the main body 7 with the engage pin 110 and the spring 12 interposed therebetween. In the sleeve portion 61, the above-described sliding slit 8a, which is faced toward a surface 50f at which the sleeve portion 61 and the hook portion 4 are arranged side by side, is formed at the interface 50c between the integrally-formed portion 50a and the divided body 50b.

Owing to this, it is possible to achieve the relational configurations in the fourth embodiment such that: the ridges 91 of the operating portion 90 are exposed to the outside from the sleeve portion 57 through the sliding slit 8a; the side walls 51, provided with the ridges 91 of the operating portion 90, cover the body 92 from both sides thereof; and the guard portion 58 is positioned on the hook portion 4 side in the operating portion 90 at a position corresponding to the closed position of the engage pin 110, with the surface 50f at which the sleeve portion 61 and the hook portion 4 are arranged side by side being faced. Note that in the second, third, and fourth embodiments, the sliding slit 8a faces the contour of the main body 7.

As a result, in addition to the case of the fourth embodiment, and in comparison with the cases where the exposure of the operating portion 90 is faced toward the contour of the main body 7, the probability of avoiding the occurrence of hitching from the hook portion 4 side, exerted in the direction of the opening operation by another object, especially the connection object, can be further increased. The ridges 91 of the present example are obtained by repeatedly arranging an angle protrusion of the original embodiment. A pitch therebetween and a height thereof are set to be smaller than those in the aforementioned examples. Thus, the degree of slipperiness with respect to the D-ring, a cloth or string for an animal, and other objects with protrusions and recesses, can be further increased. At the same time, a function to prevent a slip or an ability to be hitched is not so deteriorated for an operation by a finger performing a resilient pressing action, and the operability thereof is not therefore degraded.

All of the second to fifth embodiments described above have explained that an unexpected detachment of the snap hook can be prevented more reliably by: providing the restraining wall, as the first means, for restricting the movement of the connection object so that it cannot be allowed to come into contact with the operating portion by restricting a range of movement of the connection object in the hook portion of the snap hook; and additionally providing the side walls, as the second means, provided in the vicinity of the operating portion for receiving the connection object so as to prevent the connection object from coming into contact with the operating portion. However, in the snap hook according to the present invention, an unexpected detachment of the snap hook can be prevented even when only one of the restraining wall and the side walls is provided.

### INDUSTRIAL APPLICABILITY

In the snap hook provided in a collar or cloth for an animal, the present invention can prevent an unexpected detachment of a connection object such as a D-ring from the snap hook, caused by unexpected pushing back of the engage pin due to entanglement caused by a twist between the connection object and the snap hook.

### REFERENCE SIGNS LIST

1 base ring
2 stem
3 base
4 hook portion
4a, 11a end
5, 50, 55, 57, 61 sleeve portion
50a integrally-formed portion
50b divided body
50c interface
50d fastening pin
50e connection hole
50f surface at which the sleeve portion and the hook portion are arranged side by side
5a end
5b base
6 opening
7 main body
8a, 8b sliding slit
9, 90 operating portion
10 restraining wall
11, 110 engage pin
11b body
11c, 11d, 93 rib
12 spring
13 connection object
14 connection part
15 restraining window
16 leash
17 collar
18 D-ring
18a preceding part
18b following part
21 slit
22 slope
51 side wall
52 peripheral wall
56, 58 guard portion
91 ridge
92 body
100, 150, 150a, 150b, 200, 300, 400, 500 snap hook
Pp parallel portion
Pa arc portion
Ps straight portion
H operating portion projecting height
H1 operating portion exposed height
H2 operating portion lower end height
H3 ridge portion exposed height
H4 ridge lower end height
H5 guard portion height
111 loop clutch (hook portion)
111a, 111b end face of the loop clutch
112 sleeve portion
113 hook member
114 connection ring
114a through hole
115, 116 large-diameter portion
117 small-diameter portion
121 opening
122 hole
123 guiding slit
124 coil spring
125 slide bar
125a end face of the slide bar
126 knob portion (operating portion)
131 locking slit
132 transverse slit
133 longitudinal slit
150, 150a, 150b snap hook
151 leash
152 collar
153 ring

1. A snap hook for an animal, comprising:
a main body having a hook portion and a tubular sleeve portion integrally extending from a base, to which a base ring is rotatably connected, the sleeve portion and an end of the hook portion being opposed to each other to define an opening of the hook portion;
an engage pin being encased in the sleeve portion of the main body such that it can move back away from and move forth toward the end of the hook portion so as to open and close the opening, the engage pin including an operating portion used for the opening and closing operations, the operating portion being provided with a ridge exposed to outside through a sliding slit formed on a peripheral wall of the sleeve portion; and
a spring for biasing the engage pin toward the end of the hook portion so as to achieve contact therebetween, thereby maintaining the opening at a closed position, wherein
the main body includes a restraining wall which extends from the base and between the sleeve portion and the hook portion, toward a connection part where the hook portion is joined to a connection object so as to restrict the connection part between the end of the hook portion and the connection object and an allowance toward the base and which also defines a restraining window communicating with the opening and allowing for ingress and egress of the connection object.

2. A snap hook for an animal, comprising:
a main body having a hook portion and a tubular sleeve portion integrally extending from a base, to which a base ring is rotatably connected, the sleeve portion and an end of the hook portion being opposed to each other to define an opening of the hook portion;
an engage pin being encased in the sleeve portion of the main body such that it can move back away from and move forth toward the end of the hook portion so as to open and close the opening, the engage pin including an operating portion used for the opening and closing operations, the operating portion being provided with a ridge exposed to outside through a sliding slit formed on a peripheral wall of the sleeve portion; and
a spring for biasing the engage pin toward the end of the hook portion so as to achieve contact therebetween, thereby maintaining the opening at a closed position, wherein
the main body includes a restraining wall which extends from the base and between the sleeve portion and the hook portion, toward a connection part where the hook portion is joined to a connection object so as to restrict the connection part between the end of the hook portion and the connection object and an allowance toward the base and which also defines a restraining window communicating with the opening and allowing for ingress and egress of the connection object; and
with respect to the operating portion at a position corresponding to a closed position of the engage pin, the sleeve portion on the side of the hook portion includes a guard portion extruding more in an outward direction than at least an end on the side of the hook portion in a body of the operating portion so as to prevent an unexpected hitching force from being exerted on the body and the ridge of the operating portion from the hook portion side.

3. The snap hook for an animal according to claim 2, wherein the sleeve portion is configured by integrating together a portion integrally formed with the main body and a divided body formed separately from the main body with the engage pin and the spring interposed therebetween; the sliding slit, facing a contour of the main body formed by the sleeve portion and the hook portion arranged side by side or a surface at which the sleeve portion and the hook portion are arranged side by side, is formed at an interface between the integrally-formed portion and the divided body; and the guard portion positioned on the hook portion side of the sliding slit is formed by both or either of the integrally-formed portion and the divided body.

4. The snap hook for an animal according to any one of claims 2, wherein the guard portion extrudes more in the outward direction than an upper end of the ridge.

5. The snap hook for an animal according claim 2, wherein an exposed height of the ridge from the sleeve portion increases from a hook portion side toward a side opposite to the hook portion, starting from a height equal to or smaller than an extruding height of the guard portion on the side opposite to the hook portion.

6. The snap hook for an animal according to claim 1, wherein the end of the hook portion and an end of the engage pin make contact with each other in a manner such that a cleavage line therebetween inclines with respect to a direction perpendicular to an axis continuous therewith from an outer circumference to an inner circumference, toward the connection part of the hook portion.

7. The snap hook for an animal according to claim 1, wherein the sleeve portion includes a pair of side walls for covering the operating portion from both sides thereof.

8. The snap hook for an animal—according to claim 1, wherein the main body defines an approximately elliptic symmetrical contour by the base, the hook portion, the sleeve portion, and the engage pin; and the operating portion, corresponding to the closed position of the engage pin, is located between a central largest width portion in the contour of the main body and the base.

9. The snap hook for an animal according to claim 4, wherein an extruding height of the guard portion in the outward direction is increased from the hook portion side toward the ridge side in the sleeve portion.
